(19) United States
(12) Patent Application Publication
(10) Pub. No.: US 2023/0319598 A1
(43) Pub. Date: Oct. 5, 2023

(54) METHODS, DEVICES, AND SYSTEMS FOR NEGOTIATING MDT PARAMETERS FOR NETWORK OPTIMIZATION

(71) Applicant: ZTE Corporation, Shenzhen (CN)

(72) Inventors: Li YANG, Shenzhen (CN); Yan XUE, Shenzhen (CN); Feng XIE, Shenzhen (CN)

(73) Assignee: ZTE Corporation, Shenzhen (CN)

(21) Appl. No.: 18/205,047

(22) Filed: Jun. 2, 2023

Related U.S. Application Data
(63) Continuation of application No. PCT/CN2021/083184, filed on Mar. 26, 2021.

(51) Int. Cl. H04W 24/02; H04B 17/15; H04W 76/20

(52) U.S. Cl. CPC H04W 24/02; H04B 17/15; H04W 76/20

(57) ABSTRACT

The present disclosure describes methods, system, and devices for negotiating minimization of drive test (MDT) parameters of user equipment (UE). One method includes receiving, by a radio access network (RAN) node, a first message from a core network (CN) or an operation and maintain system (OAM), the first message comprising at least one of a negotiable or a non-negotiable MDT configuration parameter; in response to receiving the first message, determining whether the UE is suitable to carry out a MDT task corresponding to the first message; in response to the determining that the UE is suitable to carry out the MDT task corresponding to the first message, sending a second message to the UE; receiving a third message from the UE, the third message comprising at least a value suggested by the UE for the negotiable MDT configuration parameter; and sending a fourth message to the CN or the OAM.

### TECHNICAL FIELD

The present disclosure is directed generally to wireless communications. Particularly, the present disclosure relates to methods, devices, and systems for negotiating minimization of drive test (MDT) parameters for network (NW) optimization.

### BACKGROUND

Wireless communication technologies are moving the world toward an increasingly connected and networked society. In some previous generation of wireless communications, manual driving test has been used to perform various kinds of driving test against various network associated objects and quantities. This manual driving test is time consuming and costly. In recent developing generations of wireless communications, minimization of drive test (MDT) emerges to replace manual driving test to perform various kinds of driving test of MDT tasks against various network associated objects and quantities and to collect MDT measurement results.

However, there are various problems/issues associated with the present MDT framework. For example but not limited to, one problem/issue may be that the present MDT mechanism framework including a user equipment (UE) capable of MDT may be in a passive role; and/or another problem/issue may be that MDT configuration parameters are always subject to MDT configuration by a network side; and/or the UE may not negotiate about those configured MDT configuration parameters, even if the UE finds themselves not suitable.

The present disclosure describes various embodiments for negotiating minimization of drive test (MDT) parameters for network (NW) optimization, addressing at least one of the problems/issues discussed above. The present disclosure may enhance MDT mechanism and configuration of selecting and configuring UE with various MDT tasks, improving a technology field in the wireless communication.

### SUMMARY

This document relates to methods, systems, and devices for wireless communication, and more specifically, for negotiating minimization of drive test (MDT) parameters for network (NW) optimization.

In one embodiment, the present disclosure describes a method for wireless communication. The method includes negotiating, by a radio access network (RAN) node, a minimization of drive test (MDT) configuration parameter of a user equipment (UE) by receiving, by the RAN node, a first message from a core network (CN) or an operation and maintain system (OAM), the first message comprising at least one of a negotiable MDT configuration parameter or a non-negotiable MDT configuration parameter; in response to receiving the first message, determining, by the RAN node, whether the UE is suitable to carry out a MDT task corresponding to the first message, in response to the determining that the UE is suitable to carry out the MDT task corresponding to the first message; sending, by the RAN node, a second message to the UE, the second message comprising at least one of the negotiable MDT configuration parameter or the non-negotiable MDT configuration parameter; receiving, by the RAN node, a third message from the UE, the third message comprising at least a value suggested by the UE for the negotiable MDT configuration parameter; and sending, by the RAN node, a fourth message to the CN or the OAM, the fourth message comprising the value suggested by the UE for the negotiable MDT configuration parameter.

In another embodiment, the present disclosure describes a method for wireless communication. The method includes negotiating, by a radio access network (RAN) node, a minimization of drive test (MDT) configuration parameter of a user equipment (UE) by receiving, by the RAN node, a first message from the UE, the first message indicating a willingness status of the UE for a MDT task; and sending, by the RAN node, a second message to a core network (CN) or an operation and maintain system (OAM), the second message indicating the willingness status of the UE for the MDT task to the CN or the OAM.

In another embodiment, the present disclosure describes a method for wireless communication. The method includes negotiating, by a user equipment (UE), a minimization of drive test (MDT) configuration parameter of the UE according to a first message, a second message, a third message, and a fourth message by receiving, by the UE, the second message from a radio access network (RAN) node, the second message comprising at least one of a negotiable MDT configuration parameter or a non-negotiable MDT configuration parameter, wherein the RAN node receives the first message from a core network (CN) or an operation and maintain system (OAM), the first message comprising at least one of the negotiable MDT configuration parameter or the non-negotiable MDT configuration parameter; in response to receiving the first message, the RAN node determines whether the UE is suitable to carry out a MDT task corresponding to the first message; and in response to the determining that the UE is suitable to carry out the MDT task corresponding to the first message, the RAN node sends the second message to the UE; sending, by the UE, the third message to the RAN node, the third message comprising at least a value suggested by the UE for the negotiable MDT configuration parameter, so that the RAN node sends the fourth message to the CN or the OAM; the fourth message comprising the value suggested by the UE for the negotiable MDT configuration parameter.

In another embodiment, the present disclosure describes a method for wireless communication. The method includes negotiating, by a core network (CN), a minimization of drive test (MDT) configuration parameter of a user equipment (UE) by sending, by the CN, a first message to a radio access network (RAN) node, the first message comprising at least one of a negotiable MDT configuration parameter or a non-negotiable MDT configuration parameter, so that in response to receiving the first message, the RAN node determines whether the UE is suitable to carry out a MDT task corresponding to the first message; in response to the determining that the UE is suitable to carry out the MDT task corresponding to the first message, the RAN node sends a second message to the UE, the second message comprising at least one of the negotiable MDT configuration parameter or the non-negotiable MDT configuration parameter; and the RAN node receives a third message from the UE, the third message comprising at least a value suggested by the UE for the negotiable MDT configuration parameter; and receiving, by the CN, a fourth message from the RAN node, the fourth message comprising the value suggested by the UE for the negotiable MDT configuration parameter.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include a core network, a wireless network node, and one or more user equipment.

FIG. 1B shows a schematic diagram of configuring a user equipment (UE) for minimization of drive test (MDT).

FIG. 2 shows an example of a wireless network node.

FIG. 3 shows an example of a user equipment.

FIG. 4 shows a flow diagram of a method for wireless communication.

FIG. 5 shows a flow diagram of a method for wireless communication.

FIG. 6 shows a flow diagram of a method for wireless communication.

FIG. 7 shows a flow diagram of a method for wireless communication.

FIG. 8 shows an exemplary logic flow of a method for wireless communication.

FIG. 9 shows another exemplary logic flow of a method for wireless communication.

FIG. 10 shows a schematic diagram of various embodiments for negotiating a MDT configuration parameter of a UE.

FIG. 11 shows another schematic diagram of various embodiments for negotiating a MDT configuration parameter of a UE.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various methods and devices for negotiating minimization of drive test (MDT) parameters for network (NW) optimization.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

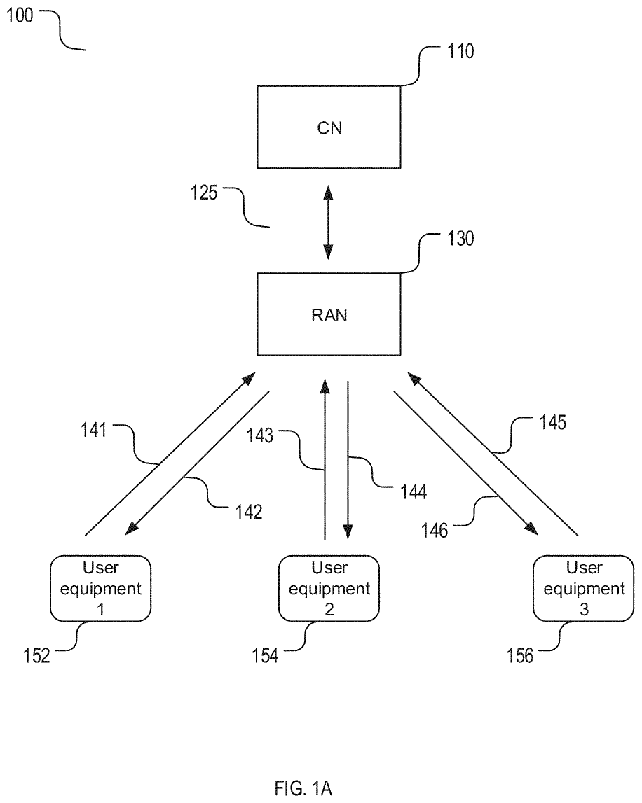

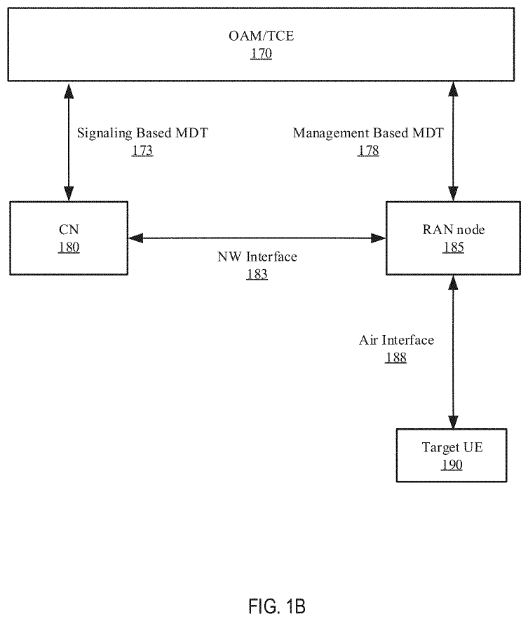

FIG. 1A shows a wireless communication system 100 including a core network (CN) 110, a wireless node 130, and one or more user equipment (UE) (152, 154, and 156). The wireless node 130 may include a wireless network base station, a radio access network (RAN) node, or a NG radio access network (NG-RAN) base station or node, which may include a nodeB (NB, e.g., a gNB) in a mobile telecommunications context. In one implementation, the core network 110 may include a 5G core network (5GC or SGCN), and the interface 125 may include a NG interface. The wireless node 130 (e.g, RAN) may include an architecture of separating a central unit (CU) and one or more distributed units (DUs).

The communication between the RAN and the one or more UE may include at least one radio bearer (RB) or channel (RB/channel). Referring to FIG. 1A, a first UE 152 may wirelessly receive from the RAN 130 via a downlink RB/channel 142 and wirelessly send communication to the RAN 130 via a uplink RB/channel 141. Likewise, a second UE 154 may wirelessly receive communicate from the RAN 130 via a uplink RB/channel 144 and wirelessly send communication to the RAN 130 via a uplink RB/channel 143; and a third UE 156 may wirelessly receive communicate from the RAN 130 via a uplink RB/channel 146 and wirelessly send communication to the RAN 130 via a uplink RB/channel 145.

In some previous generation of wireless communications, manual driving test has been used to perform various kinds of driving test against various network associated objects and quantities. This manual driving test is time consuming and costly. In recent developing generations of wireless communications, minimization of drive test (MDT) emerges to replace manual driving test to perform various kinds of driving test of MDT tasks against various network associated objects and quantities and to collect MDT measurement results.

With the latest development of MDT techniques in 3GPP industry field, the NW may select and configure one or more proper UE to perform various kinds of driving test of MDT tasks against various NW associated objects and/or quantities. The NW may collect and retrieve MDT measurement results (e.g., MDT logs) from the one or more participating UE. The NW may optimize itself in various performance aspects, such as radio coverage, radio capacity, service parameter setting, etc.

However, there are various problems/issues associated with the present MDT framework. For example but not limited to, one problem/issue may be that the present MDT mechanism framework including a user equipment (UE) capable of MDT may be in a passive role; and/or another problem/issue may be that MDT configuration parameters are always subject to MDT configuration by a network (NW) side; and/or the UE may not negotiate about those configured MDT configuration parameters, even if the UE finds them not suitable.

In some MDT mechanism framework, a selection of target MDT task UE and MDT configuration information are always subject to NW internal algorithms of itself, i.e., NW decides which UE to take over which MDT task, and then the selected UE may follow those MDT configuration to perform the expected MDT tasks in best effort basis. For example, in a particular coverage area, a NW may select a target UE (e.g., UE-A) and configure the MDT configuration parameter “MDT area scope” with cell1+cell2+cell3, but the UE-A actually may only move in or around cell2+cell3+cell4, so that the UE-A cannot perform any relevant MDT measurements regarding cell1 at all. For another example, for a particular purpose, the NW may select a target UE (e.g., UE-B) and configure the MDT configuration parameter, MDT Logging duration, with 120 minutes, but the UE-B may have insufficient buffer or insufficient battery resources and cannot measure and record the MDT logs for the length of 120 minutes. The above examples at least may show that the MDT configuration information may not well adapt to UE's local situation sometimes, hence resulting in non-optimized MDT configuration.

Under some of these circumstances, a UE capable of MDT may be always in passive role and awaiting the MDT task selection by a NW, i.e., a UE volunteering for one or more MDT tasks may not be selected or configured by a NW in proper service and mobility context. For example, in a particular coverage place, when there is one volunteer UE (e.g, UE-C) with a service-X volunteering to perform a MDT task there, but the NW may not select or configure the UE-C with the relevant MDT tasks, resulting in that the NW may miss the valuable MDT measurement results for the particular coverage place with the service-X accordingly.

The present disclosure describes various embodiments for negotiating minimization of drive test (MDT) configuration parameters for network (NW) optimization, addressing at least one of the problems/issues discussed above. The present disclosure is beneficial wherein the NW is able to negotiate with one or more UE ahead about detailed MDT configuration information and to exchange the UE's willingness to take over specific MDT tasks beyond the NW's original vision. The present disclosure may enhance MDT mechanism and configuration of selecting and configuring UE with various MDT tasks, improving a technology field in the wireless communication.

FIG. 1B shows a schematic diagram for a NW to select and configure a proper UE for expected MDT tasks. The NW may include a CN 180 and/or a RAN node 185. The CN 180 and/or the RAN node 185 may communicate with an operation and maintenance (OAM) including a trace collection entity (TCE) 170 via for a signaling based MDT 173 and/or a management based MDT 178, respectively. The CN 180 may communicate with the RAN node 185 via a NW interface 183. The RAN node 185 may communicate with a target UE 190 via an air interface 188.

In the classic cellular mobile systems such as 4G Long Term Evolution-Advanced (LTE-A) and 5G New Radio (NR), the MDT feature may be implemented to replace or supplement the legacy costly manual driving test. The LTE-A system may introduce a series of (enhanced) MDT features, and the NR system may introduce a series of (enhanced) MDT features. For both LTE-A and NR systems, the NW (e.g., CN or RAN) may select and configure one or more proper target UE(s) to perform various kinds of MDT tasks against various NW associated objects and/or quantities. The NW may collect and retrieve MDT measurement results from those UEs via signaling radio bearer (SRB) in the air, and may further upload the MDT measurement results (e.g., MDT logs) onto up streamed TCE in the OAM. Based on those MDT measurement results and logs, the NW may analyze and figure out various NW problems and defects so that the NW may further optimize itself in many performance aspects, such as radio coverage, radio capacity, service parameter settings, etc.

The TCE in OAM 170 may trigger and initiate one or more MDT tasks towards the CN 180 firstly, and then the CN may trigger and initiate the MDT tasks towards a certain RAN node to communicate with a specific target UE. The RAN node 185 may configure the target UE 190 with the one or more particular MDT tasks via SRB in the air. In one implementation, the above procedure may be called signaling based MDT.

In another implementation, the TCE in OAM 170 may trigger and initiate one or more MDT tasks towards a certain RAN node directly but without indicating specific target UE, and then the RAN node may locally select, for example, based on management based MDT PLMN list from user consent information, and may configure a particular target UE with one or more particular MDT tasks via SRB in the air. The above procedure may be called management based MDT. Optionally, in some implementations above, it may be always the NW (CN or RAN) to select the proper UE(s) for expected MDT tasks.

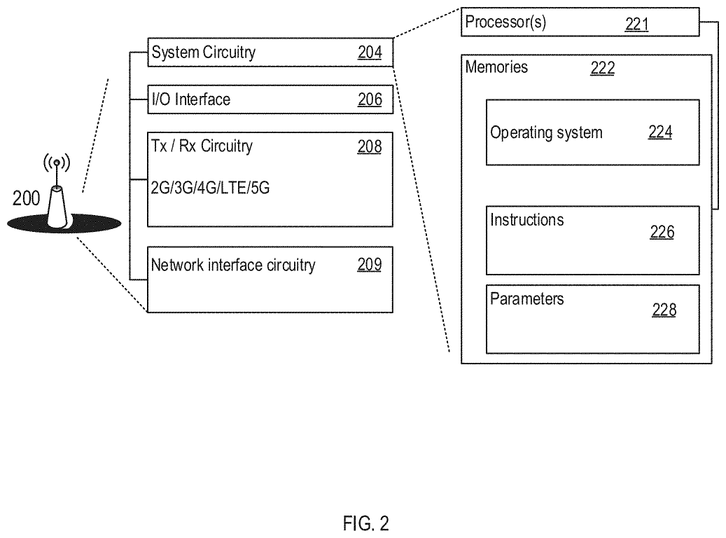

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

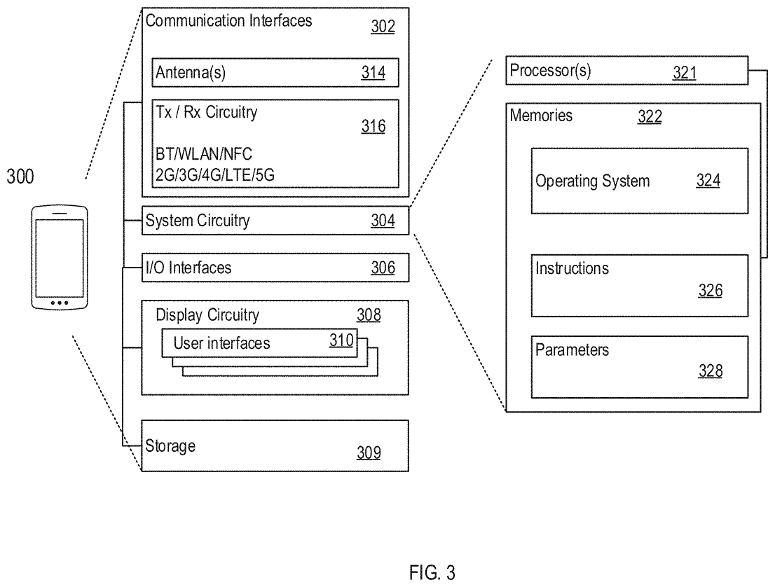

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316, which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers, and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes various embodiments for negotiating minimization of drive test (MDT) parameters for network (NW) optimization, which may be implemented, partly or totally, on one or more electronic device 200 and/or one or more terminal device 300 described above in FIGS. 2-3.

In the present disclosure, one or more framework and procedure for signaling based MDT and management based MDT may be inherited and reused partially or in its entirety as much as possible. For a portion or all existing MDT configuration information may include, for example but not limited to, an information element (IE) “MDT Configuration-NR” and/or “MDT Configuration-EUTRA”, and potentially new MDT configuration information, an NW, which may include a CN, and/or a RAN, may negotiate with the target UE about those MDT configuration information ahead before really configuring the target UE to perform the expected MDT tasks, so that the MDT configuration information may better adapt/suit to RAN and UE's local situation.

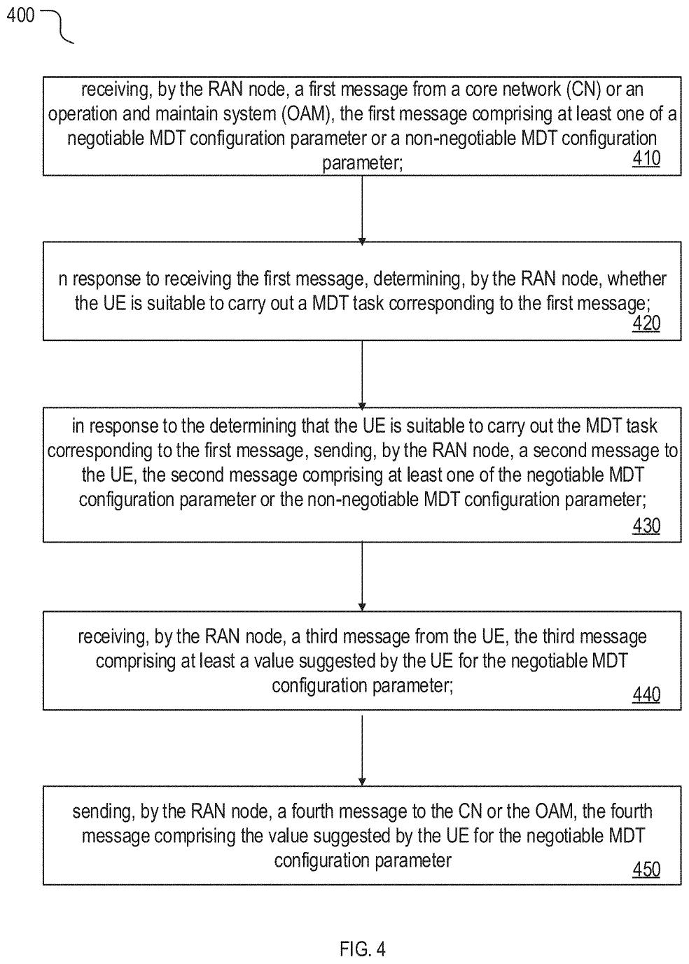

In one embodiment, referring to FIG. 4, a method 400 for wireless communication includes negotiating, by a radio access network (RAN) node, a minimization of drive test (MDT) configuration parameter of a user equipment (UE). The method 400 may include a portion or all of the following steps: step 410: receiving, by the RAN node, a first message from a core network (CN) or an operation and maintain system (OAM), the first message comprising at least one of a negotiable MDT configuration parameter or a non-negotiable MDT configuration parameter; step 420: in response to receiving the first message, determining, by the RAN node, whether the UE is suitable to carry out a MDT task corresponding to the first message; step 430: in response to the determining that the UE is suitable to carry out the MDT task corresponding to the first message, sending, by the RAN node, a second message to the UE, the second message comprising at least one of the negotiable MDT configuration parameter or the non-negotiable MDT configuration parameter; step 440: receiving, by the RAN node, a third message from the UE, the third message comprising at least a value suggested by the UE for the negotiable MDT configuration parameter; and/or step 450: sending, by the RAN node, a fourth message to the CN or the OAM, the fourth message comprising the value suggested by the UE for the negotiable MDT configuration parameter.

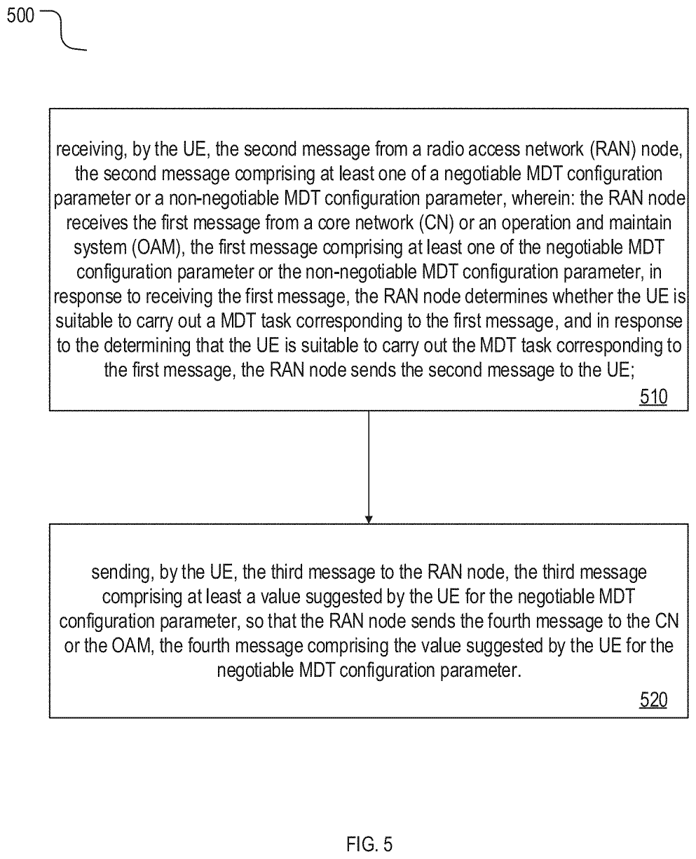

In another embodiment, referring to FIG. 5, a method 500 for wireless communication includes negotiating, by a user equipment (UE), a minimization of drive test (MDT) configuration parameter of the UE according to a first message, a second message, a third message, and a fourth message. The method 500 may include a portion or all of the following steps: step 510: receiving, by the UE, the second message from a radio access network (RAN) node, the second message comprising at least one of a negotiable MDT configuration parameter or a non-negotiable MDT configuration parameter, wherein the RAN node receives the first message from a core network (CN) or an operation and maintain system (OAM), the first message comprising at least one of the negotiable MDT configuration parameter or the non-negotiable MDT configuration parameter; in response to receiving the first message, the RAN node determines whether the UE is suitable to carry out a MDT task corresponding to the first message, and in response to the determining that the UE is suitable to carry out the MDT task corresponding to the first message, the RAN node sends the second message to the UE; step 520: sending, by the UE, the third message to the RAN node, the third message comprising at least a value suggested by the UE for the negotiable MDT configuration parameter, so that the RAN node sends the fourth message to the CN or the OAM, the fourth message comprising the value suggested by the UE for the negotiable MDT configuration parameter.

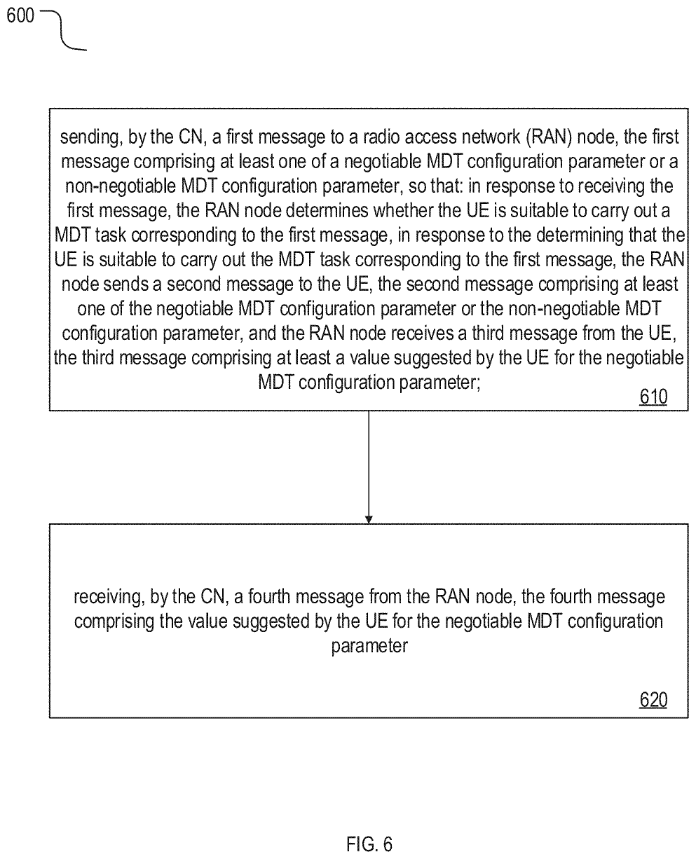

In another embodiment, referring to FIG. 6, a method 600 for wireless communication includes negotiating, by a core network (CN), a minimization of drive test (MDT) configuration parameter of a user equipment (UE). The method 600 may include a portion or all of the following steps: step 610: sending, by the CN, a first message to a radio access network (RAN) node, the first message comprising at least one of a negotiable MDT configuration parameter or a non-negotiable MDT configuration parameter, so that in response to receiving the first message, the RAN node determines whether the UE is suitable to carry out a MDT task corresponding to the first message; in response to the determining that the UE is suitable to carry out the MDT task corresponding to the first message, the RAN node sends a second message to the UE, the second message comprising at least one of the negotiable MDT configuration parameter or the non-negotiable MDT configuration parameter; and the RAN node receives a third message from the UE, the third message comprising at least a value suggested by the UE for the negotiable MDT configuration parameter; and step 620: receiving, by the CN, a fourth message from the RAN node, the fourth message comprising the value suggested by the UE for the negotiable MDT configuration parameter.

In one implementation, the first message comprises at least one of the following: a trace start message; an initial context setup request; or a HANDOVER REQUEST message. In another implementation, the HANDOVER REQUEST message may refer to as the handover request message.

In another implementation, the first message comprises at least one of the following: an information element indicating whether a procedure is for a MDT configuration parameter negotiating process; or an information element indicating whether a MDT configuration parameter is negotiable.

In another implementation, the MDT configuration parameter negotiating process is for a unreal MDT configuring process; and the information element indicating that the MDT configuration parameter is negotiable comprises at least one of the following: an information element indicating whether an area scope of MDT is negotiable, or an information element indicating whether a logging duration is negotiable. In one implementation, the unreal MDT configuration process may refer to a MDT configuration process which does not require the receiving UE to perform a corresponding MDT task right away and/or which allows a MDT configuration parameter negotiation process for the UE to participate.

In another implementation, in response to the negotiable MDT configuration parameter, a value of the negotiable MDT configuration parameter is suggested by at least one of the following: the RAN node; or the UE.

In another implementation, in response to the negotiable MDT configuration parameter, the first message comprises a range for the negotiable MDT configuration parameter.

In another implementation, in response to the determining that the UE is not suitable to carry out the MDT task corresponding to the first message, sending, by the RAN node, a dedicated message to the CN or the OAM indicating the UE being unsuitable to carry out the MDT task.

In another implementation, the dedicated message comprises a cause value indicating unsuitable MDT task holder.

In another implementation, the second message comprises a radio resource control (RRC) message comprising a RRC reconfiguration message.

In another implementation, the second message indicates whether a procedure is for a MDT configuration parameter negotiating process as a unreal MDT configuring process.

In another implementation, the second message indicates a negotiable part and a non-negotiable part in a MDT configuration.

In another implementation, the second message indicates a valid range for the negotiable MDT configuration parameter.

In another implementation, in response to receiving the second message and determining that a value of the negotiable MDT configuration parameter is not suitable, the UE sends to the RAN node the third message comprising a value suggested by the UE for the negotiable MDT configuration parameter; in response to receiving the second message and determining that the value of the negotiable MDT configuration parameter is suitable, the UE follows the value of negotiable MDT configuration parameter and sends to the RAN node the third message comprising the same value for the negotiable MDT configuration parameter; and in response to receiving the second message comprising the non-negotiable MDT configuration parameter, the UE follows the value of non-negotiable MDT configuration parameter.

In various embodiments, any one of the methods 400, 500, or 600 may further include receiving, by the RAN node, a fifth message from the CN or the OAM, the fifth message comprising at least one non-negotiable MDT configuration item for the UE to perform; and/or sending, by the RAN node, a configuration message to the UE, the configuration message comprising the at least one MDT configuration item, so that the UE performs according to the at least one MDT configuration item and reports a MDT measurement result.

In various embodiments, any one of the methods 400, 500, or 600 may further include receiving, by the RAN node, a sixth message from the UE, the sixth message comprising at least a updated value suggested by the UE for the negotiable MDT configuration parameter; and sending, by the RAN node, a seventh message to the CN or the OAM, the seventh message comprising the updated value suggested by the UE for the negotiable MDT configuration parameter.

In one implementation, the sixth message comprises a RRC message comprising at least one of the following: UE assistant information; or UE negotiating Information. In another implementation, the UE negotiating Information may be a newly specified UE negotiating Information.

In another implementation, the seventh message comprises a next generation application protocol (NGAP) trace parameter update indication message.

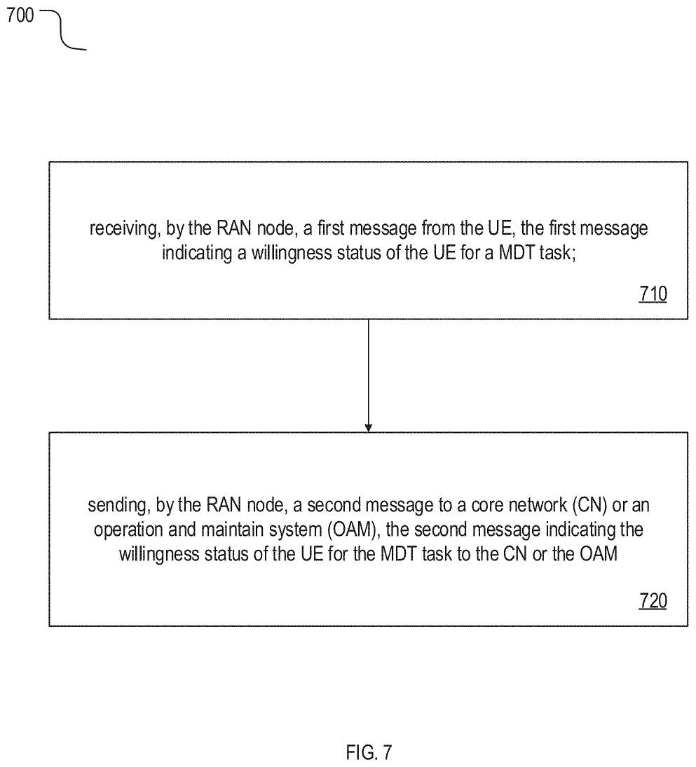

In another embodiment, referring to FIG. 7, a method 700 for wireless communication includes negotiating, by a radio access network (RAN) node, a minimization of drive test (MDT) configuration parameter of a user equipment (UE). The method 700 may include a portion or all of the following steps: step 710: receiving, by the RAN node, a first message from the UE, the first message indicating a willingness status of the UE for a MDT task; and step 720: sending, by the RAN node, a second message to a core network (CN) or an operation and maintain system (OAM), the second message indicating the willingness status of the UE for the MDT task to the CN or the OAM.

In one implementation, the first message comprises a RRC message comprising at least one of the following: UE assistant information; or UE negotiating Information.

In another implementation, the second message comprises a next generation application protocol (NGAP) trace failure indication message.

In another implementation, in response to the willingness status of the UE for the MDT task being negative, the CN or the OAM avoids selecting the UE to perform the corresponding MDT task.

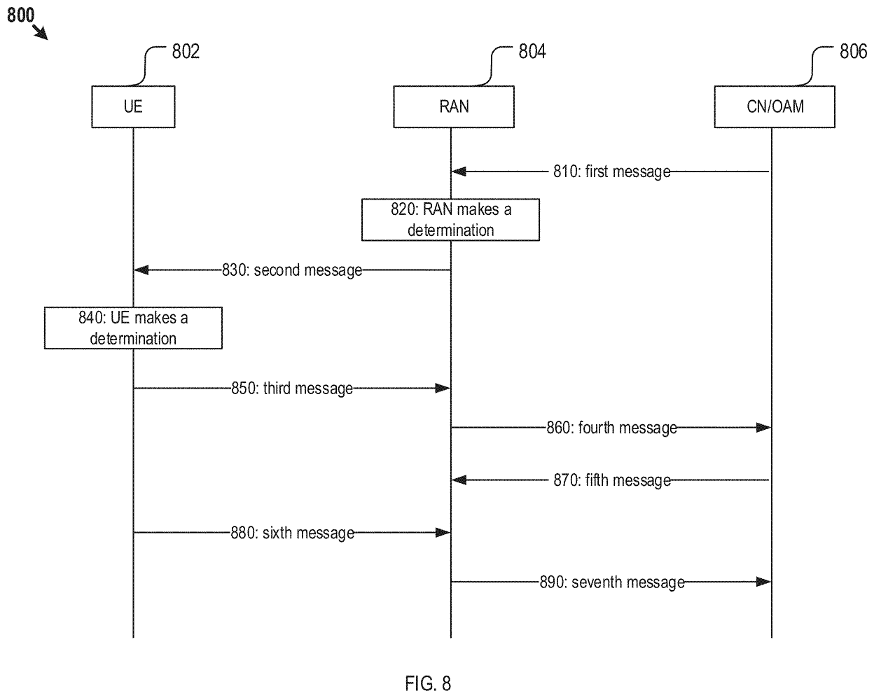

FIG. 8 shows an exemplary logic flow of the various embodiments for wireless communication. Any embodiment in the present disclosure may include a portion or all of the steps in FIG. 8. A method 800 in FIG. 8 may include one or more CN/OAM 806, one or more RAN 804, and/or one or more UE 802.

Referring to step 810, the CN/OAM may send a first message to the RAN. The CN or OAM triggers and initiates the procedure/message. The first message may be “TRACE START” or “INITIAL CONTEXT SETUP REQUEST” or “HANDOVER REQUEST” containing the negotiable and non-negotiable MDT configuration for the purpose of negotiating MDT configuration parameter towards the serving RAN node.

In one implementation, within the procedure/message for negotiating MDT configuration parameter, the CN or OAM indicates whether the procedure/message is for the purpose of negotiating MDT configuration, i.e., the RAN node needs not to really follow or configure them directly to the UE afterwards.

In another implementation, within the procedure/message for negotiating MDT configuration parameter, the CN or OAM indicates which MDT configuration parameter in the MDT configuration is negotiable or not (negotiable part and non-negotiable part), i.e., the value of MDT configuration parameter may be suggested and updated by RAN or UE afterwards, adapting to RAN or UE's local situation.

In another implementation, for the negotiable MDT configuration parameter in the MDT configuration, the CN or OAM indicates the valid range if applicable, i.e., the new value of MDT configuration parameter must be suggested and updated within the valid range.

Referring to step 820, upon receiving the first message (for example, the procedure/message for negotiating MDT configuration parameter), the RAN node may make a determination. The RAN may compile and analyze the content of a given MDT configuration, and determine firstly whether a target UE is a suitable UE to take over the corresponding MDT task.

In response to determining that the target UE is not a suitable UE to take over the corresponding MDT task, the RAN node may initiate and send a dedicated procedure/message with the appropriate cause value, e.g., “Unsuitable MDT task holder” towards the CN or OAM.

In response to determining that the target UE is a suitable UE to take over the corresponding MDT task, the RAN node may send a second message (in step 830), for example, the second message may be a RRC procedure/message, e.g., “RRC RECONFIGURATION” containing the negotiable and non-negotiable MDT configuration parameters towards target UE.

Referring to step 830, the RAN node may initiates and sends the second message, for example, a RRC procedure/message containing the negotiable and non-negotiable MDT configuration parameters towards UE.

In one implementation, within the procedure/message for negotiating MDT configuration parameter, the RAN node indicates whether the procedure/message is for the purpose of negotiating MDT configuration, i.e., UE needs not to follow them directly to perform the corresponding MDT tasks right away afterwards.

In another implementation, within the procedure/message for negotiating MDT configuration parameter, the RAN node indicates which MDT configuration parameter in the MDT configuration is negotiable or not (negotiable part and non-negotiable part), i.e., the value of MDT configuration parameter can be suggested and updated by UE afterwards, adapting to UE's local situation.

In one implementation, for the negotiable MDT configuration parameter in the MDT configuration, the RAN node indicates the valid range if applicable, i.e., the new value of MDT configuration parameter must be suggested and updated within the valid range.

Referring to step 840, upon receiving the RRC procedure/message for negotiating MDT configuration, the UE may compile and analyze the content of given MDT configuration, and determine whether the value of negotiable MDT configuration parameter is suitable or not.

In response to determining that the value of negotiable MDT configuration parameter is not suitable, the UE may initiate and send a third message, for example, a dedicated RRC procedure/message, with the suggested new value for all negotiable MDT configuration parameters (in step 850).

In response to determining that the value of negotiable MDT configuration parameter is suitable, the UE may also initiate a third message, for example, a dedicated RRC procedure/message, with the given value for all negotiable MDT configuration parameters (in step 850), i.e., confirm and follow the NW's MDT configuration.

In another implementation, for the non-negotiable MDT configuration parameters, UE may always accept and follow them unless reconfigured by NW later.

Referring to step 860, upon receiving the RRC procedure/message for the updated MDT configuration from the UE, the RAN node may compile and send a fourth message, for example, a procedure/message, containing the updated MDT configuration towards the CN or OAM, so that the CN or OAM knows the RAN or UE's local situation.

Referring to step 870, after above round of MDT configuration parameter negotiating process, which may include steps 810-860, the CN or OAM may trigger and initiate a fifth message, for example, a procedure/message, containing a real (non-negotiable) MDT configuration for the real MDT work towards the serving RAN node as specified at that moment.

Referring to step 880, by keeping negotiable MDT configuration parameter in mind for a period of time, without another round of MDT configuration parameter negotiating process, the UE may actively initiate and send a sixth message, for example, a dedicated RRC procedure/message, e.g., UE ASSISTANT INFORMATION, with the suggested new value for the negotiable MDT configuration parameters, so that the CN or OAM knows the RAN or the UE's local situation.

Referring to step 890, upon receiving the RRC procedure/message with the suggested new value for the negotiable MDT configuration parameters from the UE, the RAN node may compile and send a seventh message, for example, a procedure/message, containing the suggested new value for the negotiable MDT configuration parameters towards the CN or OAM, so that the CN or OAM knows the RAN or UE's local situation.

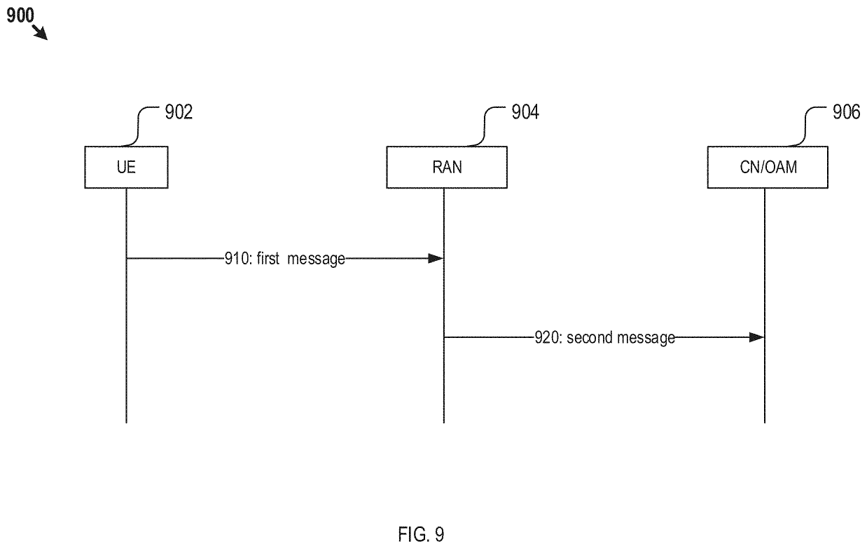

FIG. 9 shows an exemplary logic flow of the various embodiments for wireless communication. Any embodiment in the present disclosure may include a portion or all of the steps in FIG. 9. A method 900 in FIG. 9 may include one or more CN/OAM 906, one or more RAN 904, and/or one or more UE 902.

Referring to step 910, without a previous MDT configuration parameter negotiating process, the UE may actively initiate and send to the RAN a first message, for example, a dedicated RRC procedure/message, e.g., UE ASSISTANT INFORMATION, indicating its willingness or not for a particular MDT task, so that the CN or OAM knows the UE's volunteering status to avoid unsuitable target UE selection.

Referring to step 920, upon receiving the first message indicating the UE's willingness or not for a particular MDT task from the UE, the RAN node may compile and send a second message, for example, a procedure/message, containing the indication indicating the UE's willingness or not for a particular MDT task towards the CN or OAM, so that the CN or OAM knows the UE's volunteering status to avoid unsuitable target UE selection.

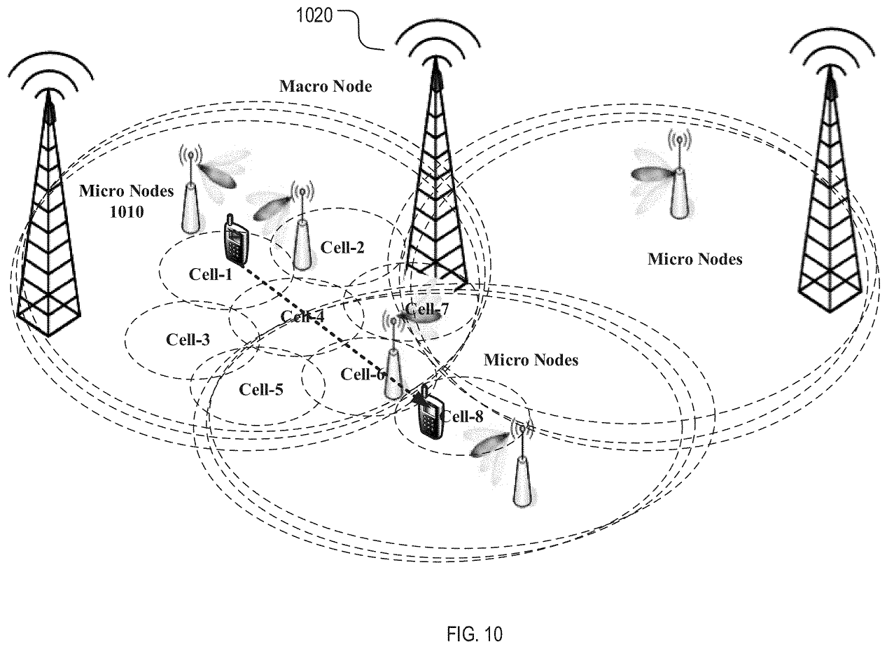

For one example of various embodiments, as shown in FIG. 10, a 5G HetNet consists of one or more macro RAN nodes 1020 and one or more micro RAN nodes 1010 to adapt the coverage and/or capacity requirement in a certain serving area. A user (e.g., Tom) is volunteering to perform MDT tasks per his specific subscriber contract with the mobile operator, and Tom is currently in Cell-1 and communicating with a NW in a RRC_Connected state. The NW expects Tom (or any other volunteer) to perform certain MDT tasks, e.g., measuring the radio coverage status in the nearby areas. Without aforementioned MDT configuration parameter negotiating process, the NW may configure the existing IE “Cell ID List for MDT” in “Area Scope of MDT” with non-optimal cell list, incurring inefficient MDT configuration.

An exemplary procedure for negotiating a MDT configuration parameter of a UE is described below. The procedure in various embodiments may include a portion or all the following steps, wherein the steps may be performed in the order described below or in a different order.

Step 11: The 5GC or OAM sends the existing NGAP: TRACE START or INITIAL CONTEXT SETUP REQUEST or HANDOVER REQUEST message to the RAN node serving “Tom” at the moment, including the MDT configuration information for the purpose of measuring radio coverage. Besides the normal MDT configuration information, e.g., as specified in NGAP TS38.413 nowadays, it additionally contains the new specified IE “MDT parameter negotiating process”=TRUE and new specified IE “Area Scope of MDT negotiable”=TRUE. As MDT configuration baseline, 5GC or OAM configures the IE “Cell ID List for MDT” in “Area Scope of MDT” with “Cell-1, Cell-2, Cell-3, Cell-4, Cell-5, Cell-7”.

Step 12: Upon receiving the NGAP: TRACE START or INITIAL CONTEXT SETUP REQUEST or HANDOVER REQUEST message, the RAN node compiles and analyzes the MDT configuration and confirms that the UE of “Tom” is the suitable target UE to perform the MDT task, so continues sending the relevant MDT configuration information with non-negotiable and negotiable part to UE of “Tom” via existing RRC RECONFIGURATION message.

Step 13: Upon receiving the RRC RECONFIGURATION message, the UE of “Tom” obtains the non-negotiable and negotiable part of MDT configuration information, so knowing that the NW expects to perform the specific MDT tasks for measuring radio coverage in the valid area consisting of “Cell-1, Cell-2, Cell-3, Cell-4, Cell-5, Cell-7”.

Step 14: “Tom” is supposed to move along the path indicated in FIG. 1, i.e., from Cell-1->Cell-4->Cell-6->Cell-8. Since the new specified IE “MDT parameter negotiating process”=TRUE, Tom knows that this is not real MDT configuring process but MDT configuration parameter negotiating process. Since the new specified IE “Area Scope of MDT negotiable”=TRUE, Tom knows that the parameter of “Area Scope of MDT” is negotiable, so Tom decides to suggest new value for IE “Cell ID List for MDT” in “Area Scope of MDT” with “Cell-1, Cell-4, Cell-6, Cell-8” (adapting to its moving path). After that, UE shall send the UE ASSISTANT INFORMATION message, containing above suggested new values for real MDT configuring reference.

Step 15: Upon receiving the UE ASSISTANT INFORMATION message from UE, the RAN node obtains the suggested new value for the IE “Cell ID List for MDT” in “Area Scope of MDT” with “Cell-1, Cell-4, Cell-6, Cell-8”, hence continues sending the suggested new MDT configuration to 5GC or OAM with new specified NGAP: TRACE PARAMETER UPDATE INDICATION message.

Step 16: Upon receiving the TRACE PARAMETER UPDATE INDICATION message, the 5GC or OAM obtains the suggested new value for the IE “Cell ID List for MDT” in “Area Scope of MDT” with “Cell-1, Cell-4, Cell-6, Cell-8”, and decides to accept them for subsequent real MDT configuring process.

Step 17: The 5GC or OAM sends again the NGAP: TRACE START message to the RAN node serving “Tom” at the moment, including the MDT configuration information for the purpose of measuring radio coverage. Besides the normal MDT configuration information, e.g., as specified in NGAP TS38.413 nowadays, it additionally contains the new specified IE “MDT parameter negotiating process”=FALSE and new specified IE “Area Scope of MDT negotiable”=FALSE. As real MDT configuration, 5GC configures the updated value for IE “Cell ID List for MDT” in “Area Scope of MDT” with “Cell-1, Cell-4, Cell-6, Cell-8”. The subsequent real MDT configuring process are the same as specified today. For the negotiable part, the updated value of certain MDT configuration parameter shall replace previous one. For the non-negotiable part, the previous value of certain MDT configuration parameter shall remain unless reconfigured by NW later.

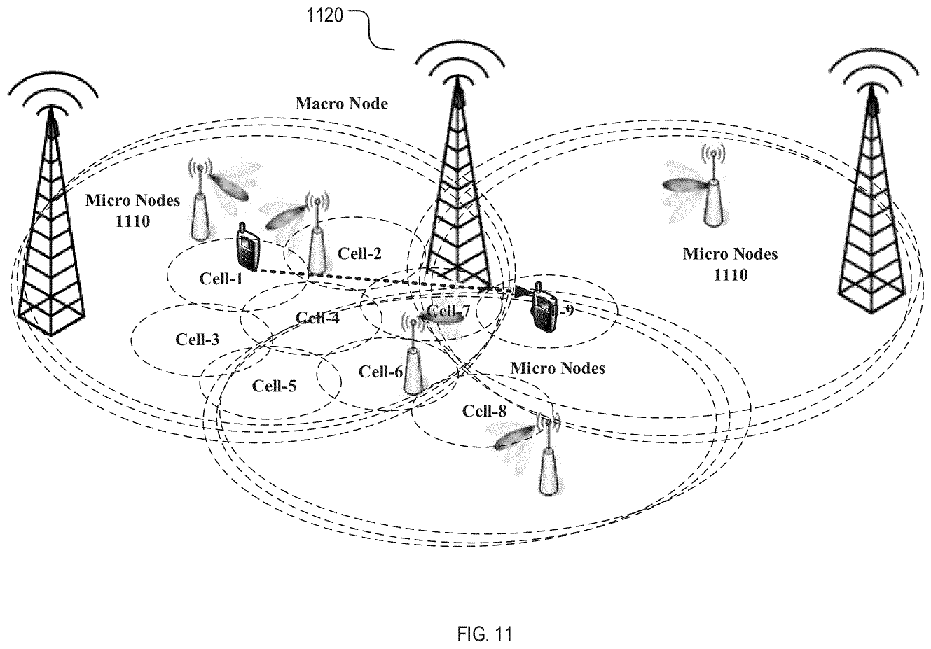

For another example of various embodiments, as shown in FIG. 11, a 5G HetNet consists of one or more macro RAN nodes 1120 and one or more micro RAN nodes 1110 to adapt the coverage and/or capacity requirement in a certain serving area. A user (e.g., Jack) is volunteering to perform MDT tasks per his specific subscriber contract with the mobile operator, and Jack is currently in Cell-1 and communicating with a NW in a RRC_Connected state. The NW expects “Jack” (or any other volunteer) to perform certain MDT tasks, e.g., measuring the average throughput/data rate status in the nearby areas. Without aforementioned MDT configuration parameter negotiating process, the NW may configure the existing IE “Cell ID List for MDT” in “Area Scope of MDT” with non-optimal cell list, incurring inefficient MDT configuration.

An exemplary procedure for negotiating a MDT configuration parameter of a UE is described below. The procedure in various embodiments may include a portion or all the following steps, wherein the steps may be performed in the order described below or in a different order.

Step 21: The 5GC or OAM sends the existing NGAP: TRACE START or INITIAL CONTEXT SETUP REQUEST or HANDOVER REQUEST message to the RAN node serving “Jack” at the moment, including the MDT configuration information for the purpose of measuring average throughput/data rate. Besides the normal MDT configuration information, e.g., as specified in NGAP TS38.413 nowadays, it additionally contains the new specified IE “MDT parameter negotiating process”=FALSE and new specified IE “Area Scope of MDT negotiable”=TRUE. As real MDT configuring process, 5GC or OAM configures the IE “Cell ID List for MDT” in “Area Scope of MDT” with “Cell-1, Cell-2, Cell-3, Cell-4, Cell-5, Cell-7”.

Step 22: Upon receiving the NGAP: TRACE START or INITIAL CONTEXT SETUP REQUEST or HANDOVER REQUEST message, the RAN node compiles and analyzes the MDT configuration and confirms that the UE of “Jack” is the suitable target UE to perform the MDT task, so continues sending the relevant MDT configuration information with non-negotiable and negotiable part to UE of “Jack” via existing RRC RECONFIGURATION message.

Step 23: Upon receiving the RRC RECONFIGURATION message, the UE of “Jack” obtains the non-negotiable and negotiable part of MDT configuration information, so knowing that the NW expects to perform the specific MDT tasks for measuring average throughput/data rate in the valid area consisting of “Cell-1, Cell-2, Cell-3, Cell-4, Cell-5, Cell-7”.

Step 24: “Jack” is supposed to move along the path indicated in FIG. 2, i.e., from Cell-1->Cell-2->Cell-7->Cell-9. Since the new specified IE “MDT parameter negotiating process”=FALSE, “Jack” knows that this is real MDT configuring process but not MDT configuration parameter negotiating process. Since the new specified IE “Area Scope of MDT negotiable”=TRUE, “Jack” knows that the parameter of “Area Scope of MDT” is negotiable, so “Jack” decides to suggest new value for IE “Cell ID List for MDT” in “Area Scope of MDT” with “Cell-1, Cell-2, Cell-7, Cell-9” (adapting to its moving path). After that, UE shall send the UE ASSISTANT INFORMATION message, containing above suggested new values for NW's MDT reconfiguring reference in future.

Step 25: Upon receiving the UE ASSISTANT INFORMATION message from UE, the RAN node obtains the suggested new value for the IE “Cell ID List for MDT” in “Area Scope of MDT” with “Cell-1, Cell-2, Cell-7, Cell-9”, hence continues sending the suggested new MDT configuration to 5GC or OAM with new specified NGAP: TRACE PARAMETER UPDATE INDICATION message.

Step 26: Upon receiving the TRACE PARAMETER UPDATE INDICATION message, the 5GC or OAM obtains the suggested new value for the IE “Cell ID List for MDT” in “Area Scope of MDT” with “Cell-1, Cell-2, Cell-7, Cell-9”, but needs not to update them immediately, and may take them into account in future, e.g., in another MDT reconfiguring process.

Step 27: Since it is one real MDT configuring process, the 5GC or OAM shall not send again the NGAP: TRACE START message to the RAN node serving “Jack” immediately, and the UE of “Jack” shall perform the expected MDT task, i.e., measuring average throughput/data rate for this MDT task session until it is reconfigured by NW for another MDT task session later.

For another example of various embodiments, as shown in FIG. 10, a 5G HetNet consists of one or more macro RAN nodes 1020 and one or more micro RAN nodes 1010 to adapt the coverage and/or capacity requirement in a certain serving area. A user (e.g., Lucy) is volunteering to perform MDT tasks per her specific subscriber contract with the mobile operator, and “Lucy” is currently in Cell-1 and camped in a RRC_Idle state. The NW expects “Lucy” (or any other volunteer) to perform certain MDT tasks, e.g., measuring the MBS signal coverage status in the nearby areas. Without aforementioned MDT configuration parameter negotiating process, the NW may configure the existing IE “Logging duration” in IE “Logged MDT” with a non-optimal value, incurring UE battery over-draining.

An exemplary procedure for negotiating a MDT configuration parameter of a UE is described below. The procedure in various embodiments may include a portion or all the following steps, wherein the steps may be performed in the order described below or in a different order.

Step 31: The UE of “Lucy” is paged to enter a RRC_Connected state for MDT configuring reason. The 5GC or OAM sends the existing NGAP: TRACE START or INITIAL CONTEXT SETUP REQUEST or HANDOVER REQUEST message to the RAN node serving “Lucy” at the moment, including the MDT configuration information for the purpose of measuring MBS signal coverage. Besides the normal MDT configuration information, e.g., as specified in NGAP TS38.413 nowadays, it additionally contains the new specified IE “MDT parameter negotiating process”=TRUE and new specified IE “Logging duration negotiable”=TRUE. As MDT configuration baseline, 5GC or OAM configures the IE “Logging duration” in IE “Logged MDT” with “120 minutes”.

Step 32: Upon receiving the NGAP: TRACE START or INITIAL CONTEXT SETUP REQUEST or HANDOVER REQUEST message, the RAN node compiles and analyzes the MDT configuration and confirms that the UE of “Lucy” is the suitable target UE to perform the MDT task, so continues sending the relevant MDT configuration information with non-negotiable and negotiable part to UE of “Lucy” via existing RRC RECONFIGURATION message.

Step 33: Upon receiving the RRC RECONFIGURATION message, the UE of “Lucy” obtains the non-negotiable and negotiable part of MDT configuration information, so knowing that the NW expects to perform the specific MDT tasks for measuring MBS signal coverage, in the manner of logged MDT for a period of 120 minutes.

Step 34: “Lucy” is supposed to move along the path indicated in FIG. 1, i.e., from Cell-1->Cell-4->Cell-6->Cell-8. Since the new specified IE “MDT parameter negotiating process”=TRUE, “Lucy” knows that this is not real MDT configuring process but MDT configuration parameter negotiating process. Since the new specified IE “Logging duration negotiable”=TRUE, “Lucy” knows that the parameter of “Logging duration” is negotiable, so for UE batter saving reasons, “Lucy” decides to suggest new value for IE “Logging duration” in “Logged MDT” with “60 minutes” (adapting to Lucy's situation). After that, UE shall send the UE ASSISTANT INFORMATION message, containing above suggested new values for real MDT configuring reference.

Step 35: Upon receiving the UE ASSISTANT INFORMATION message from UE, the RAN node obtains the suggested new value for the IE “Logging duration” in “Logged MDT” with “60 minutes”, hence continues sending the suggested new MDT configuration to 5GC or OAM with new specified NGAP: TRACE PARAMETER UPDATE INDICATION message.

Step 36: Upon receiving the TRACE PARAMETER UPDATE INDICATION message, the 5GC or OAM obtains the suggested new value for the IE “Logging duration” in “Logged MDT” with “60 minutes”, and decides to accept them for subsequent real MDT configuring process.

Step 37: The 5GC or OAM sends again the NGAP: TRACE START message to the RAN node serving “Lucy” at the moment, including the MDT configuration information for the purpose of measuring MBS signal coverage. Besides the normal MDT configuration information, e.g., as specified in NGAP TS38.413 nowadays, it additionally contains the new specified IE “MDT parameter negotiating process”=FALSE and new specified IE “Logging duration negotiable”=FALSE. As real MDT configuration, 5GC configures the updated value for IE “Logging duration” in “Logged MDT” with “60 minutes”. The subsequent real MDT configuring process are the same as specified today. For the negotiable part, the updated value of certain MDT configuration parameter shall replace previous one. For the non-negotiable part, the previous value of certain MDT configuration parameter shall remain unless reconfigured by NW later.

For another example of various embodiments, a user (e.g., Lucy) is a volunteer to perform MDT tasks and has performed MDT tasks before. According to the history information of her MDT tasks, “Lucy” may actively report her local situation to assist the potential forthcoming MDT configuration parameter configuring for new MDT tasks.

An exemplary procedure for negotiating a MDT configuration parameter of a UE is described below. The procedure in various embodiments may include a portion or all the following steps, wherein the steps may be performed in the order described below or in a different order.

Step 41: the UE of “Lucy” knows which MDT configuring parameter may be negotiable according her configured MDT tasks before. Her UE battery life is only “60 minutes” sustainable and not supposed to perform high consuming MDT tasks. “Lucy” decides to suggest the value for IE “Logging duration” in “Logged MDT” with “60 minutes”. Then, “Lucy” actively initiates and sends the UE ASSISTANT INFORMATION message, containing above suggested values for real MDT configuring reference before NW's real MDT configuring process.

Step 42: Upon receiving the UE ASSISTANT INFORMATION message from UE, the RAN node obtains the suggested value for the IE “Logging duration” in “Logged MDT” with “60 minutes”, hence sends the suggested MDT configuration to 5GC or OAM with specified NGAP: TRACE PARAMETER UPDATE INDICATION message.

Step 43: Upon receiving the TRACE PARAMETER UPDATE INDICATION message, the 5GC or OAM obtains the suggested new value for the IE “Logging duration” in “Logged MDT” with “60 minutes”, and may assign a low consuming MDT tasks to “Lucy” with the suggested value in forthcoming MDT configuring process.

For another example of various embodiments, as shown in FIG. 10, a user (e.g., Tom) is volunteering to perform MDT tasks per his specific subscriber contract with the mobile operator. The NW expects “Tom” (or any other volunteer) to perform certain MDT tasks, e.g., measuring the average throughput/data rate status in the nearby areas. Multiple times of MDT configuration parameter negotiation may be needed to get the most appropriate value of MDT configuring parameter for “Tom”.

An exemplary procedure for negotiating a MDT configuration parameter of a UE is described below. The procedure in various embodiments may include a portion or all the following steps, wherein the steps may be performed in the order described below or in a different order.

Step 51: The UE of “Tom” in MDT task has obtained the non-negotiable and negotiable part of MDT configuration information, so knowing that the NW expects him to perform the specific MDT tasks for measuring average throughput/data rate in the valid area consisting of “Cell-1, Cell-2, Cell-3, Cell-4, Cell-5, Cell-7”.

Step 52: “Tom” knows that the parameter of “Area Scope of MDT” and “Logging duration” are both negotiable, so “Tom” decides to suggest new value for IE “Cell ID List for MDT” in “Area Scope of MDT” with “Cell-1, Cell-4, Cell-6, Cell-8” (adapting to its moving path as in FIG. 1). After that, UE shall send the UE ASSISTANT INFORMATION message, containing above suggested new values for real MDT configuring reference.

Step 53: Upon receiving the UE ASSISTANT INFORMATION message from UE, the RAN node obtains the suggested new value for the IE “Cell ID List for MDT” in “Area Scope of MDT” with “Cell-1, Cell-4, Cell-6, Cell-8”, hence continues sending the suggested new MDT configuration to 5GC or OAM with new specified NGAP: TRACE PARAMETER UPDATE INDICATION message.

Step 54: Upon receiving the TRACE PARAMETER UPDATE INDICATION message, the 5GC or OAM obtains the suggested new value for the IE “Cell ID List for MDT” in “Area Scope of MDT” with “Cell-1, Cell-4, Cell-6, Cell-8”. According to the suggested new MDT valid area from “Tom”, the 5GC or OAM decides to modify the IE “Cell ID List for MDT” to “Cell-1, Cell-4, Cell-6” (without Cell-8) for the subsequent real MDT configuring process.

Step 55: After receiving the new IE “Cell ID List for MDT” with “Cell-1, Cell-4, Cell-6”, “Tom” finds his UE battery can only support the MDT valid area of “Cell-1, Cell-4”. So “Tom” decides to send the UE ASSISTANT INFORMATION message again, containing “Cell ID List for MDT” in “Area Scope of MDT” with “Cell-1, Cell-4” and “Logging duration” in “Logged MDT” with “30 minutes”.

Step 56: Upon receiving the TRACE PARAMETER UPDATE INDICATION message again, the 5GC or OAM decides to re-configure the value for “Cell ID List for MDT” of in “Area Scope of MDT” with “Cell-1, Cell-4” and “Logging duration” in “Logged MDT” with “30 minutes” for “Tom”.

For another example of various embodiments, as shown in FIG. 10, a user (e.g., Tom) is volunteering to perform MDT tasks per his specific subscriber contract with the mobile operator. The NW expects “Tom” (or any other volunteer) to perform certain MDT tasks, e.g., measuring the average throughput/data rate status in the nearby areas. “Tom” may reject the requested MDT configuration according to his local decision.

An exemplary procedure for negotiating a MDT configuration parameter of a UE is described below. The procedure in various embodiments may include a portion or all the following steps, wherein the steps may be performed in the order described below or in a different order.

Step 61: the UE of “Tom” in MDT task has obtained the non-negotiable and negotiable part of MDT configuration information, so knowing that the NW expects him to perform the specific MDT tasks for measuring average throughput/data rate in the valid area consisting of “Cell-1, Cell-2, Cell-3, Cell-4, Cell-5, Cell-7”.

Step 62: “Tom” finds his UE battery cannot support the MDT valid area so decides to reject the MDT task. After that, UE shall send the UE ASSISTANT INFORMATION message, containing above rejecting indication and cause value for the MDT configuring reference.

Step 63: Upon receiving the UE ASSISTANT INFORMATION message from UE, the RAN node sends the rejecting indication and cause value to 5GC or OAM with existing TRACE FAILURE INDICATION message.

Step 64: Upon receiving the TRACE FAILURE INDICATION message, the 5GC or OAM obtains the rejecting indication from “Tom”. Then, 5GC or OAM decides to terminate the MDT tasks of “Tom”.

The present disclosure describes methods, apparatus, and computer-readable medium for wireless communication. The present disclosure addressed the issues with negotiating a minimization of drive test (MDT) configuration parameter of a user equipment (UE). The methods, devices, and computer-readable medium described in the present disclosure may facilitate the performance of wireless communication by negotiating a MDT configuration parameter of a UE, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
negotiating, by a radio access network (RAN) node, a minimization of drive test (MDT) configuration parameter of a user equipment (UE) by:
receiving, by the RAN node, a first message from a core network (CN) or an operation and maintain system (OAM), the first message comprising at least one of a negotiable MDT configuration parameter or a non-negotiable MDT configuration parameter;
in response to receiving the first message, determining, by the RAN node, whether the UE is suitable to carry out a MDT task corresponding to the first message;
in response to the determining that the UE is suitable to carry out the MDT task corresponding to the first message, sending, by the RAN node, a second message to the UE, the second message comprising at least one of the negotiable MDT configuration parameter or the non-negotiable MDT configuration parameter;
receiving, by the RAN node, a third message from the UE, the third message comprising at least a value suggested by the UE for the negotiable MDT configuration parameter; and
sending, by the RAN node, a fourth message to the CN or the OAM, the fourth message comprising the value suggested by the UE for the negotiable MDT configuration parameter.

2. The method according to claim 1, wherein:
the first message comprises at least one of the following:
a trace start message;
an initial context setup request; or
a handover request message.

3. The method according to claim 1, wherein:
the first message comprises at least one of the following:
an information element indicating whether a procedure is for a MDT configuration parameter negotiating process; or
an information element indicating whether a MDT configuration parameter is negotiable.

4. (canceled)

5. The method according to claim 1, wherein:
in response to the negotiable MDT configuration parameter, a value of the negotiable MDT configuration parameter is suggested by at least one of the following:
the RAN node; or
the UE.

6. The method according to claim 1, wherein:
in response to the negotiable MDT configuration parameter, the first message comprises a range for the negotiable MDT configuration parameter.

7. The method according to claim 1, further comprising:
in response to the determining that the UE is not suitable to carry out the MDT task corresponding to the first message, sending, by the RAN node, a dedicated message to the CN or the OAM indicating the UE being unsuitable to carry out the MDT task.

8. (canceled)

9. The method according to claim 1, wherein:
the second message comprises a radio resource control (RRC) message comprising a RRC reconfiguration message.

10. The method according to claim 1, wherein:
the second message indicates whether a procedure is for a MDT configuration parameter negotiating process as a unreal MDT configuring process.

11. The method according to claim 1, wherein:
the second message indicates a negotiable part and a non-negotiable part in a MDT configuration.

12. The method according to claim 1, wherein:
the second message indicates a valid range for the negotiable MDT configuration parameter.

13. The method according to claim 1, wherein:
in response to receiving the second message and determining that a value of the negotiable MDT configuration parameter is not suitable, the UE sends to the RAN node the third message comprising a value suggested by the UE for the negotiable MDT configuration parameter;
in response to receiving the second message and determining that the value of the negotiable MDT configuration parameter is suitable, the UE follows the value of negotiable MDT configuration parameter and sends to the RAN node the third message comprising the same value for the negotiable MDT configuration parameter; and
in response to receiving the second message comprising the non-negotiable MDT configuration parameter, the UE follows the value of non-negotiable MDT configuration parameter.

14. The method according to claim 1, further comprising:
receiving, by the RAN node, a fifth message from the CN or the OAM, the fifth message comprising at least one non-negotiable MDT configuration item for the UE to perform; and
sending, by the RAN node, a configuration message to the UE, the configuration message comprising the at least one MDT configuration item, so that the UE performs according to the at least one MDT configuration item and reports a MDT measurement result.

15. The method according to claim 1, further comprising:
receiving, by the RAN node, a sixth message from the UE, the sixth message comprising at least a updated value suggested by the UE for the negotiable MDT configuration parameter; and
sending, by the RAN node, a seventh message to the CN or the OAM, the seventh message comprising the updated value suggested by the UE for the negotiable MDT configuration parameter.

16-29. (canceled)

30. An apparatus comprising:
a memory storing instructions; and
a processor in communication with the memory, wherein, when the processor executes the instructions, the processor is configured to cause the apparatus to perform negotiating a minimization of drive test (MDT) configuration parameter of a user equipment (UE) by:
receiving a first message from a core network (CN) or an operation and maintain system (OAM), the first message comprising at least one of a negotiable MDT configuration parameter or a non-negotiable MDT configuration parameter;
in response to receiving the first message, determining whether the UE is suitable to carry out a MDT task corresponding to the first message;
in response to the determining that the UE is suitable to carry out the MDT task corresponding to the first message, sending a second message to the UE, the second message comprising at least one of the negotiable MDT configuration parameter or the non-negotiable MDT configuration parameter;
receiving a third message from the UE, the third message comprising at least a value suggested by the UE for the negotiable MDT configuration parameter; and
sending a fourth message to the CN or the OAM, the fourth message comprising the value suggested by the UE for the negotiable MDT configuration parameter.

31. The apparatus according to claim 30, wherein:
the first message comprises at least one of the following:
a trace start message;
an initial context setup request; or
a handover request message.

32. The apparatus according to claim 30, wherein:
the first message comprises at least one of the following:
an information element indicating whether a procedure is for a MDT configuration parameter negotiating process; or
an information element indicating whether a MDT configuration parameter is negotiable.

33. The apparatus according to claim 30, wherein:
in response to the negotiable MDT configuration parameter, the first message comprises a range for the negotiable MDT configuration parameter.

34. A non-transitory computer program product comprising a computer-readable program medium storing instructions, wherein, the instructions, when executed by a processor, are configured to cause the processor to perform negotiating a minimization of drive test (MDT) configuration parameter of a user equipment (UE) by:
receiving a first message from a core network (CN) or an operation and maintain system (OAM), the first message comprising at least one of a negotiable MDT configuration parameter or a non-negotiable MDT configuration parameter;
in response to receiving the first message, determining whether the UE is suitable to carry out a MDT task corresponding to the first message;
in response to the determining that the UE is suitable to carry out the MDT task corresponding to the first message, sending a second message to the UE, the second message comprising at least one of the negotiable MDT configuration parameter or the non-negotiable MDT configuration parameter;
receiving a third message from the UE, the third message comprising at least a value suggested by the UE for the negotiable MDT configuration parameter; and
sending a fourth message to the CN or the OAM, the fourth message comprising the value suggested by the UE for the negotiable MDT configuration parameter.

35. The non-transitory computer program product according to claim 34, wherein:
the first message comprises at least one of the following:
a trace start message;
an initial context setup request; or
a handover request message.

36. The non-transitory computer program product according to claim 34, wherein:
the first message comprises at least one of the following:
an information element indicating whether a procedure is for a MDT configuration parameter negotiating process; or
an information element indicating whether a MDT configuration parameter is negotiable.
